(19) United States
(12) Patent Application Publication
(10) Pub. No.: US 2012/0017854 A1
(43) Pub. Date: Jan. 26, 2012

(54) MOTOR VEHICLE

(75) Inventors: Michael Hölscher, Wimsheim (DE); Michael Baum, Tiefenbronn-Lehningen (DE)

(73) Assignee: Dr. Ing. h.c. F. Porsche Aktiengesellschaft, Stuttgart (DE)

(21) Appl. No.: 13/177,980

(22) Filed: Jul. 7, 2011

(30) Foreign Application Priority Data
Jul. 22, 2010 (DE) 10 2010 036 575.0

(51) Int. Cl. F02B 73/00

(52) U.S. Cl. 123/2; 180/65.225

(57) ABSTRACT

A motor vehicle, having a drive unit which includes at least one internal combustion engine, wherein the internal combustion engine has at least two component internal combustion engines each with a crankshaft and each with a defined number of cylinders, wherein each of the component internal combustion engines each has at least one separate valve drive for actuating inlet valves and outlet valves of the cylinders of the respective component internal combustion engine.

### CROSS-REFERENCE TO RELATED APPLICATION

This U.S. patent application claims priority to German Patent Application DE 10 2010 036 575.0, filed Jul. 22, 2011, which is incorporated by reference herein in its entirety.

### FIELD OF THE INVENTION

The invention relates to a motor vehicle having a drive unit which comprises at least one internal combustion engine, wherein the internal combustion engine has at least two component internal combustion engines each with a crankshaft and each with a defined number of cylinders, characterized in that each of the component internal combustion engines each has at least one separate valve drive for actuating inlet valves and outlet valves of the cylinders of the respective component internal combustion engine.

### BACKGROUND OF THE INVENTION

DE 10 2007 010 343 A1, which is incorporated by reference, discloses a motor vehicle which is embodied as a hybrid vehicle and has a drive unit, the drive unit of which motor vehicle comprises an internal combustion engine and an electric machine. The internal combustion engine of the motor vehicle which is disclosed in this prior art has two internal combustion engine units and therefore component internal combustion engines, wherein each component internal combustion engine comprises a separate crankshaft and a defined number of cylinders. A first component internal combustion engine of the motor vehicle which is disclosed in said document can be coupled to a transmission via a first clutch, wherein the electric machine also acts on the transmission. A second component internal combustion engine can be coupled to the first component internal combustion engine via a second clutch. When the second clutch is closed, a drive torque can be made available at the drive of the motor vehicle from both component internal combustion engines via the transmission. On the other hand, when the second clutch is opened, the second component internal combustion engine is decoupled from the output, with the result that said component internal combustion engine can be deactivated, wherein a drive torque can then be made available at the drive of the motor vehicle exclusively by the first component internal combustion engine of the internal combustion engine.

Although according to DE 10 2007 010 343 A1 the first component internal combustion engine can be operated independently of the second component internal combustion engine, operation of the second component internal combustion engine independently of the first component internal combustion engine is not possible according to this prior art. As a result, limitations arise in terms of the operating modes which can be implemented.

### SUMMARY OF THE INVENTION

Taking this as a basis, the present invention is based on the object of providing a novel motor vehicle. This object is achieved by means of a motor vehicle having a drive unit which comprises at least one internal combustion engine, wherein the internal combustion engine has at least two component internal combustion engines each with a crankshaft and each with a defined number of cylinders, characterized in that each of the component internal combustion engines each has at least one separate valve drive for actuating inlet valves and outlet valves of the cylinders of the respective component internal combustion engine. According to aspects of the invention, each of the component internal combustion engines each has at least one separate valve drive for actuating inlet valves and outlet valves of the cylinders of the respective component internal combustion engine.

With the present invention here it is proposed that each component internal combustion engine each has at least one separate valve drive for actuating the inlet valves and the outlet valves of the cylinders of the respective component internal combustion engine. This is a precondition for completely independent operation of all the component internal combustion engines of the motor vehicle.

Each component internal combustion engine preferably also each has a separate fuel supply system and, if appropriate, each has a separate fuel ignition system, and preferably each has a separate supply system for air and each has a separate discharge system for exhaust gas. The two component internal combustion engines are preferably controlled by one engine control unit.

According to one advantageous development of the invention, the drive unit is preferably embodied as a hybrid drive and comprises at least one electric machine in addition to the internal combustion engine, wherein a drive torque from an internal combustion engine can be applied to a first axle via at least one component internal combustion engine, and wherein an electric motor drive torque can be applied to a second axle via at least one electric machine. For this purpose, a first component internal combustion engine of the internal combustion engine is coupled to a transmission input shaft of a transmission which is coupled to the first axle, in that a second component internal combustion engine of the internal combustion engine is coupled to a first electric machine, in that a clutch is connected between the two component internal combustion engines, and in that at least one further electric machine is coupled to the second axle. Such a configuration of a motor vehicle with a hybrid drive permits particularly preferred operating modes to be implemented by reducing the fuel requirement and the CO₂ emissions of the motor vehicle.

### BRIEF DESCRIPTION OF THE DRAWING FIGURES

Preferred developments of the invention emerge from the subclaims and the following description. Exemplary embodiments of the invention are explained in more detail with reference to the drawing, without being restricted thereto. In said drawing:

FIG. 1 shows a schematic illustration of a first motor vehicle according to aspects of the invention;

FIG. 2 shows a schematic illustration of a second motor vehicle according to aspects of the invention;

FIG. 3 shows a schematic illustration of a third motor vehicle according to aspects of the invention; and

FIG. 4 shows a schematic illustration of a fourth motor vehicle according to aspects of the invention.

### DETAILED DESCRIPTION OF THE PREFERRED EMBODIMENTS

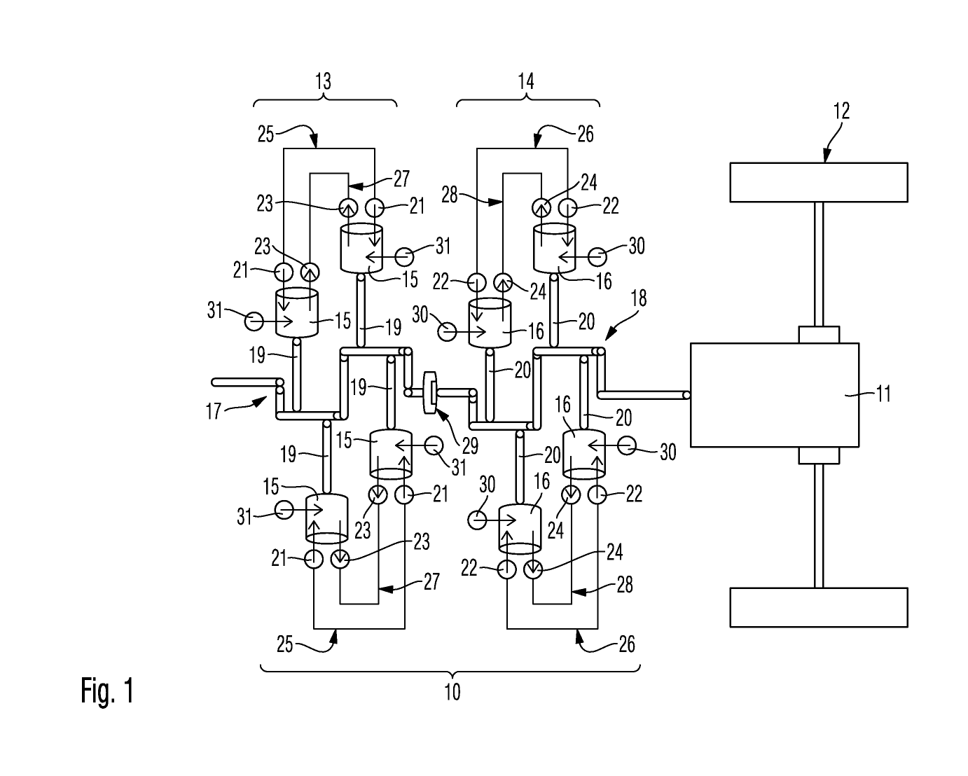

FIG. 1 shows a schematic illustration of a first exemplary embodiment of a motor vehicle according to aspects of the invention, wherein, of the motor vehicle, an internal combustion engine 10, a transmission 11 and an output in the form of a driven axle 12 of the motor vehicle are shown. The transmission 11 is connected between the internal combustion engine 10 and the output 12.

The internal combustion engine 10 has, according to FIG. 1, two component internal combustion engines 13 and 14. Each of the two component internal combustion engines 13 and 14 has a defined number of cylinders 15 and 16, respectively, as well as a crankshaft 17 or 18, respectively. The cylinders 15 and 16, respectively, specifically the pistons thereof, are coupled to the respective crankshafts 17 or 18, respectively, via connecting rods 19 or 20, respectively. In the exemplary embodiment in FIG. 1, each component internal combustion engine 13 and 14 comprises, in addition to the crankshaft 17 or 18, four cylinders 15 and 16, respectively, with the result that the internal combustion engine 10 as a whole has eight cylinders 15, 16 with a symmetrical division between the component internal combustion engines 13 and 14.

In order to permit the component internal combustion engines 13 and 14 to operate independently of one another, each of the component internal combustion engines 13 and 14 each comprises at least one separate valve drive for actuating inlet valves 21 and 22, respectively, and outlet valves 23 and 24, respectively, of the cylinders 15 and 16, respectively. It is therefore possible to see in FIG. 1 that in the exemplary embodiment shown each cylinder 15 or 16, respectively, of each component internal combustion engine 13 or 14, respectively, is each assigned an inlet valve 21 or 22, respectively, for air and is each assigned an outlet valve 23 or 24, respectively, for exhaust gas, wherein these valves are also referred to as charge cycle valves. The inlet valves 21 and 22, respectively, of each component internal combustion engine 13 and 14, respectively, are each actuated by at least one separate valve drive, specifically by, in each case, at least one inlet cam valve 25 or 26, respectively. The outlet valves 23 or 24, respectively, of the component internal combustion engines 13 and 14 are also each driven by at least one separate valve drive, specifically each by at least one outlet cam shaft 27 or 28, respectively.

According to FIG. 1, a clutch 29 is connected between the two crankshafts 17 and 18 of the two component internal combustion engines 13 and 14, by which clutch 29 the two component internal combustion engines 13 and 14 can be disconnected from one another or coupled to one another via the two component internal combustion engines 13 and 14. Since the two component internal combustion engines 13 and 14 have not only separate crankshafts 17 and 18 but instead according to aspects of the invention also have at least one separate valve drive 26, 27 and 26, 28, respectively, for actuating the inlet valves 21 and 22, respectively, and the outlet valves 23 and 24, respectively, the two component internal combustion engines 13 and 14 can be operated independently of one another. It is therefore possible not only to operate the component internal combustion engine 14 when the component internal combustion engine 13 is deactivated, instead it is also possible to operate the component internal combustion engine 13 when the component internal combustion engine 14 is deactivated.

According to one advantageous development of the invention, each of the component internal combustion engines 13 and 14 of the internal combustion engine 10 of the motor vehicle according to aspects of the invention also each comprises a separate fuel supply system and, if appropriate, each comprises a separate fuel ignition system for the cylinders 15 and 16, respectively, of the respective component internal combustion engine 13 or 14, respectively. Therefore, in FIG. 1, fuel injection valves 30 and 31, respectively, of the cylinders 15 and 16, respectively, of the component internal combustion engines 13 and 14, respectively, are shown as components of the separate fuel supply systems. Furthermore, each component internal combustion engine 13, 14 each preferably has a separate supply system for air, in particular a separate collector, and each has a separate discharge system for exhaust gas, in particular a separate exhaust gas manifold as well as exhaust gas post-treatment systems. In addition, each component internal combustion engine 13 and 14 can have a separate exhaust gas turbo charger for relaxing exhaust gas discharged from the cylinders 15 and 16, respectively, and for compressing charge air which is to be fed to the cylinders 15 and 16, respectively.

An engine control unit preferably controls the operation of the two component internal combustion engines. The synchronization of the component internal combustion engines is therefore made possible and setting of a common ignition sequence in the overall operation of the two component internal combustion engines is therefore ensured.

As already stated, a clutch 29 is connected between the crankshafts 17 and 18 of the component internal combustion engines 13 and 14. When the component internal combustion engines 13 and 14 are embodied in a V design or R design, the clutch 29 is preferably embodied as a positively locking clutch which can be closed exclusively at a defined relative angular position between the crankshafts 17 and 18 and therefore the crank drives of the component internal combustion engines 13 and 14.

Internal combustion engines in a V design or R design are therefore sensitive with respect to mass equalization, with the result that the component internal combustion engines 13 and 14 can then be coupled to one another exclusively in a defined relative angular position between the respective crankshafts 17 and 18.

On the other hand, when the internal combustion engine is insensitive with respect to mass equalization, as is the case, for example, in internal combustion engines in a Boxer design, a frictionally locking clutch 29 can be positioned between the crankshafts 17 and 18 of the component internal combustion engines 13 and 14, which clutch 29 can then be closed in any relative angular position between the two crankshafts 17 and 18 and therefore crank drives of the component internal combustion engines 13 and 14.

As already stated, the component internal combustion engines 13 and 14 of the motor vehicle according to aspects of the invention can be operated completely independently of one another, that is to say can be deactivated or can run completely independently of one another. Supply systems for oil lubrication and cooling of the component internal combustion engines 13 and 14 can be actuated according to demand in order to ensure sufficient lubrication and cooling of the component internal combustion engines 13 and 14 of the internal combustion engine 10.

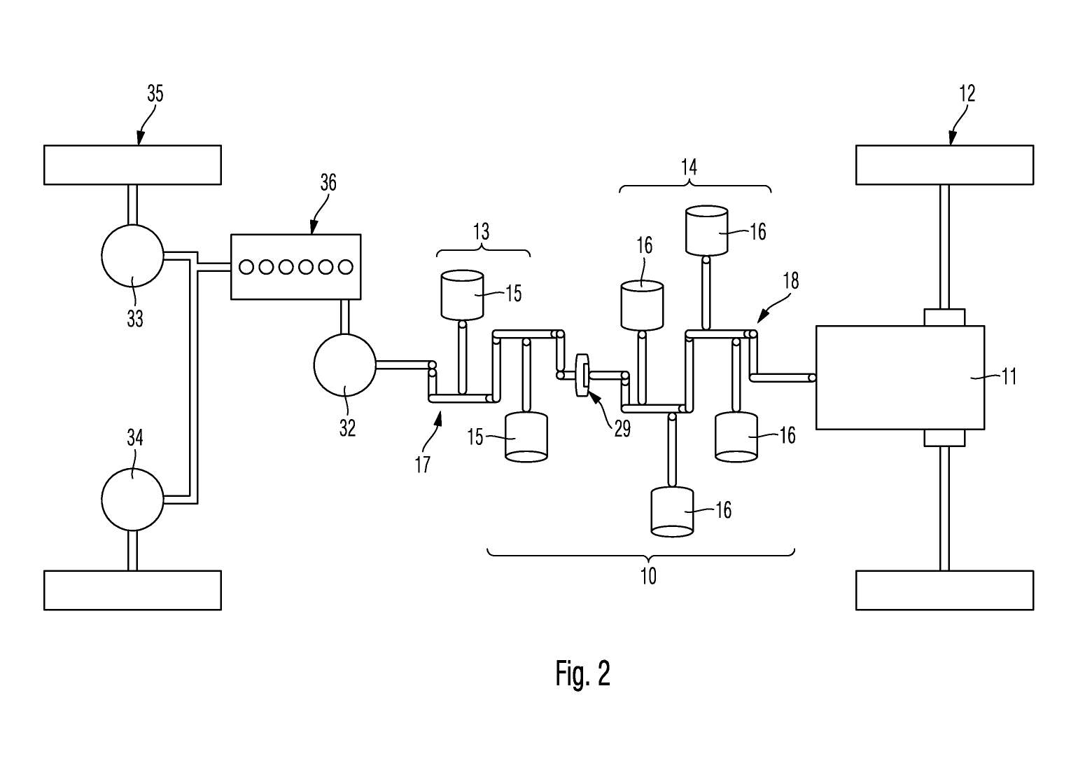

FIG. 2 shows a second exemplary embodiment of a motor vehicle according to aspects of the invention, wherein the motor vehicle in FIG. 2 also has an internal combustion engine 10 with two component internal combustion engines 13 and 14. The basic design of the internal combustion engine 10 and of the component internal combustion engines 13 and 14 of the exemplary embodiment in FIG. 2 corresponds to the exemplary embodiment in FIG. 1, with the result that, in order to avoid necessary repetitions, identical reference symbols will be used for identical assemblies. The internal combustion engine 10 in FIG. 2 differs from the internal combustion engine 10 in FIG. 1 only in that in the exemplary embodiment in FIG. 2 the internal combustion engine 10 is embodied as a 6-cylinder internal combustion engine, specifically in such a way that the first component internal combustion engine 13 is embodied as a 2-cylinder component internal combustion engine, while the component internal combustion engine 14 is embodied as a 4-cylinder component internal combustion engine. The internal combustion engine is then divided asymmetrically. However, with respect to the other details, the internal combustion engine 10 in FIG. 2 corresponds to the internal combustion engine 10 in FIG. 1.

In the exemplary embodiment in FIG. 2, the drive unit is embodied as a hybrid drive which has, in addition to the internal combustion engine 10 which comprises the two component internal combustion engines 13 and 14, at least one electric machine, specifically three electric machines 32, 33 and 34 in the exemplary embodiment shown. The electric machines 32, 33 and 34 can be operated in motor mode or generator mode.

Therefore, as in the exemplary embodiment in FIG. 2, the internal combustion engine 10, specifically the component internal combustion engine 14, is coupled to the transmission 11 and therefore to the axle 12 of the output of the motor vehicle. When the clutch 29 is closed, the component internal combustion engine 13 is also coupled to the transmission 11 and therefore to the axle 12 of the motor vehicle, wherein as a function of whether the clutch 29 is opened or closed, a drive torque from an internal combustion engine can be made available at the axle 12 either by the component internal combustion engine 14 exclusively or by both component internal combustion engines 13 and 14.

In addition to the axle 12 at which the drive torque from the internal combustion engine can be made available via the internal combustion engine 10, the output of the motor vehicle in FIG. 2 has a second driven axle 35, wherein each wheel of the axle 35 is assigned a separate electric machine 33 or 34, respectively, in order to apply an electric motor drive torque to this axle 35. Electrical energy which is required for this can be made available by an electric energy store 36, wherein the electric machine 32 is also coupled to the electric energy store 36 and acts on the crankshaft 17 of the component internal combustion engine 13.

When a power-oriented or high-performance sporting mode is to be made available for the motor vehicle in FIG. 2, the clutch 29 is closed and the two component internal combustion engines 13 and 14 run, with the result that drive torque from an internal combustion engine can be made available at the axle 12 via both component internal combustion engines 13 and 14. Furthermore, all the electric machines 32, 33 and 34 are operated either in motor mode or generator mode, specifically as a function of the current operating state of the motor vehicle. The electric machine 32, which is coupled to the crankshaft 17 of the component internal combustion engine 13, is preferably operated in generator mode in order to charge the electric energy store 36, and it can also alternatively be operated in motor mode in order to assist when calling up peak performances, for example during a boost function.

When a drive torque is to be made available at the axle 35, the electric machines 33 and 34 are operated in motor mode. However, the electric machines 33 and 34 can also be operated in generator mode in what is referred to as a regenerative operation in order, for example, to convert mechanical energy present at the axle 35 during braking into electrical energy for charging the electric energy store 36.

In order make available a normal operating mode for the drive train shown in FIG. 2, the clutch 29 is opened and the component internal combustion engine 13 is deactivated together with the electric machine 32. In this case, the component internal combustion engine 14 then runs exclusively and makes available a drive torque from an internal combustion engine at the axle 12. The electric machines 33 and 34, which are coupled to the axle 35, are operated, as a function of the current operating state, either in motor mode or in generator mode in order to make available an electric motor drive torque at the axle 35 via said electric motor in the motor mode or to charge the electric energy store 36 in the generator mode. The component internal combustion engine 13 can be started as required in the normal operating mode and coupled to the component internal combustion engine 14, or in the autonomous mode the electric machine 32 can be driven to charge the energy store 36 independently of the component internal combustion engine 14.

When a particularly fuel-saving and environmentally friendly eco-friendly operating mode is to be ensured for the motor vehicle in FIG. 2, the component internal combustion engine 14 is deactivated when the clutch 29 is opened, wherein the component internal combustion engine 13 then runs exclusively, in order to operate the electric machine 32 in generator mode and therefore charge the electric energy store 36, with the result that a sufficient quantity of energy is always available to said energy store 36 and can be used to make available an electric motor drive torque at the axle 35 via the electric machines 33 and 34. If, in this case, the electric charge state of the electric energy store 36 is sufficient, the component internal combustion engine 13 can also be deactivated. Likewise, in this case, the electric machines 33 and 34 can also be operated in generator mode during the recovery of energy.

The axle 12 is preferably a rear axle, and the axle 35 is preferably a front axle.

However, the axle 12 can also be a front axle and the axle 35 can be rear axle.

In addition, the motor vehicle in FIG. 2 can also be operated purely in internal combustion engine mode by means of the internal combustion engine 10, specifically either exclusively via the component internal combustion engine 14 or via both component internal combustion engines 13 and 14.

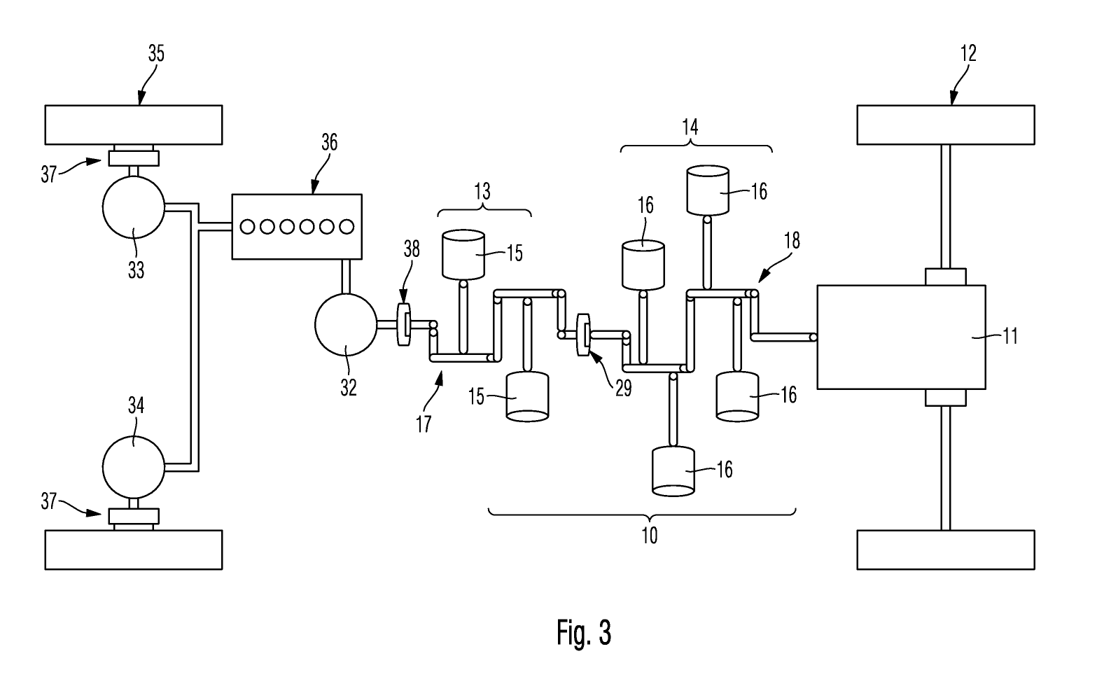

A modification of the motor vehicle in FIG. 2 is shown by FIG. 3, wherein in the case of the motor vehicle in FIG. 3 the electric machines 33 and 34 which are assigned to the axle 35 are coupled to the axle 35 via mechanical clutches 37, with the result that when the electric machines 33 and 34 are deactivated, the latter can be decoupled from the output completely in order to avoid what are referred to as zero load losses. Likewise, the electric machine 32 can be coupled to the crankshaft 17 of the component internal combustion engine 13 via a mechanical clutch 38, with the result that when the clutch 38 is opened the electric machine 32 can also be decoupled completely from the crankshaft 17 of the component internal combustion engine 13 in order to avoid zero load losses thereof.

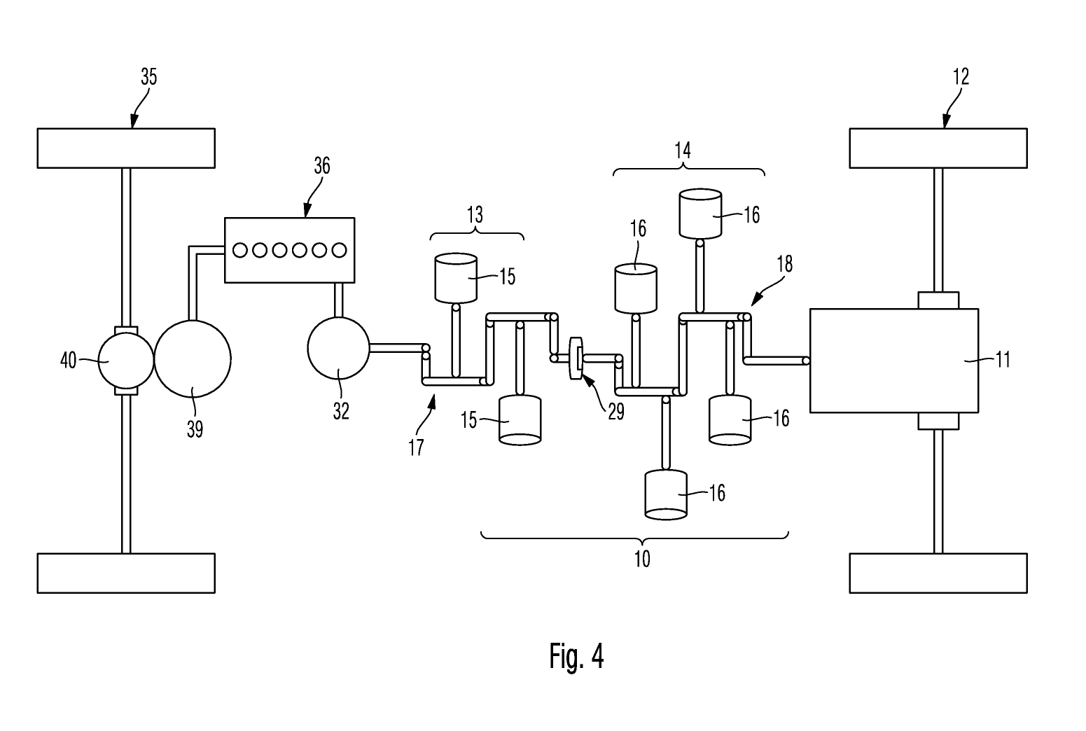

A further variant of the motor vehicle in FIG. 2 is shown in FIG. 4, wherein in the exemplary embodiment in FIG. 4 an electric machine 39 is assigned exclusively to the axle 35, which electric machine 39 acts via a differential 40 on the axle 35 and makes available an electric motor drive torque at the latter.

The two component internal combustion engines 13 and 14 of the internal combustion engines 10 in FIGS. 1 to 4 are preferably positioned in a common housing. In the sense of the present invention, when the clutch 29 is opened the two component internal combustion engines 13 and 14 can be operated independently of one another at different operating points, for example at different rotational speeds. It is therefore possible, for example, for the component internal combustion engine 13 to run at an operating point with a constant rotational speed and with an optimum level of efficiency in order to charge the energy store, while the component internal combustion engine 14 runs at a different operating point with a different rotational speed.

### LIST OF REFERENCE NUMERALS

10 Internal combustion engine

11 Transmission

12 Axle

13 Component internal combustion engine

14 Component internal combustion engine

15 Cylinder

16 Cylinder

17 Crankshaft

18 Crankshaft

19 Connecting rod

20 Connecting rod

21 Inlet valve

22 Inlet valve

23 Outlet valve

24 Outlet valve

25 Inlet cam shaft

26 Inlet cam shaft

27 Outlet cam shaft

28 Outlet cam shaft

29 Clutch

30 Fuel injection valve

31 Fuel injection valve

32 Electric machine

33 Electric machine

34 Electric machine

35 Axle

36 Energy store

37 Clutch

38 Clutch

39 Electric machine

40 Differential

1.-10. (canceled)

11. A motor vehicle comprising:
a drive unit including at least one internal combustion engine,
wherein the internal combustion engine has at least two component internal combustion engines each with a crankshaft and each with a defined number of cylinders,
wherein each of the component internal combustion engines has at least one separate valve drive for actuating inlet valves and outlet valves of the cylinders of the respective component internal combustion engine.

12. The motor vehicle as claimed in claim 11, wherein each of the component internal combustion engines has a separate fuel supply system.

13. The motor vehicle as claimed in claim 11, wherein each of the component internal combustion engines has a separate supply system for air and each has a separate discharge system for exhaust gas.

14. The motor vehicle as claimed in claim 11, wherein, in each case, a positively locking clutch is positioned between the crankshafts of adjacent component internal combustion engines which are positioned directly one behind the other, wherein the clutch is configured to be closed exclusively in a defined relative angular position between the respective crankshafts and therefore crank drives of the component internal combustion engines.

15. The motor vehicle as claimed in claim 14, wherein each component internal combustion engine is embodied in a V design or an R design.

16. The motor vehicle as claimed in claim 11, wherein, in each case, a frictionally locking clutch is positioned between the crankshafts of adjacent component internal combustion engines which are positioned directly one behind the other, wherein the clutch is configured to be closed in each relative angular position between the respective crankshafts and therefore crank drives of the component internal combustion engines.

17. The motor vehicle as claimed in claim 16, wherein each component internal combustion engine is embodied in a boxer design.

18. The motor vehicle as claimed in claim 11, wherein the drive unit is embodied as a hybrid drive and comprises at least one electric machine in addition to the internal combustion engine, wherein a drive torque from an internal combustion engine can be applied to a first axle via at least one component internal combustion engine, and wherein an electric motor drive torque can be applied to a second axle via at least one electric machine.

19. The motor vehicle as claimed in claim 18, wherein a first component internal combustion engine of the internal combustion engine is coupled to a transmission which is coupled to the first axle, a second component internal combustion engine of the internal combustion engine is coupled to a first electric machine, a clutch is connected between the two component internal combustion engines, and at least one further electric machine is coupled to the second axle.

20. The motor vehicle as claimed in claim 19, wherein, in order to make available a sporting mode when the clutch is closed, the two component internal combustion engines run, and the electric machines are configured to be operated in a motor mode or in a generator mode as a function of a current operating state of the motor vehicle.

21. The motor vehicle as claimed in claim 19, wherein, in order to make available a normal operating mode when the clutch is opened, the first component internal combustion engine runs, the second component internal combustion engine is deactivated together with the first electric machine, and the at least one further electric machine is configured to be operated in a motor mode or in a generator mode as a function of the current operating state of the motor vehicle.

22. The motor vehicle as claimed in claim 19, wherein, in order to make available an eco-friendly operating mode when the clutch is opened, the first component internal combustion engine is deactivated, the second component internal combustion engine runs together with the first electric machine which is operated in a generator mode, and the at least one further electric machine is configured to be operated in a motor mode or in a generator mode as a function of the current operating state of the motor vehicle.

23. The motor vehicle as claimed in claim 11, wherein each of the component internal combustion engines has a separate fuel ignition system for the cylinders of the respective component internal combustion engine.
